(19) United States
(12) Patent Application Publication
(10) Pub. No.: US 2004/0010481 A1
(43) Pub. Date: Jan. 15, 2004

(54) Time-dependent outcome prediction using neural networks

(75) Inventors: D.R. Mani, Boxborough, MA (US); Pablo Tamayo, Cambridge, MA (US); Jill Mesirov, Belmont, MA (US); Todd R. Golub, Newton, MA (US); Eric Lander, Cambridge, MA (US)

Correspondence Address: TESTA, HURWITZ & THIBEAULT, LLP, HIGH STREET TOWER, 125 HIGH STREET, BOSTON, MA, 02110, US

(73) Assignee: Whitehead Institute for Biomedical Research, Cambridge, MA

(21) Appl. No.: 10/316,184

(22) Filed: Dec. 9, 2002

Related U.S. Application Data
(60) Provisional application No. 60/340,087, filed on Dec. 7, 2001.

(51) Int. Cl. G06N 3/08; G06F 15/18; G06G 7/00; G06E 3/00; G06E 1/00

(52) U.S. Cl. 706/21; 706/25

(57) ABSTRACT

A neural network system and method for analyzing data sets, especially microarray gene expression data. The neural network is trained to generate time-dependent outcome predictions based on input features and outcome functions for a number of subjects. The features may be highly dimensional relative to the number of subjects, and feature selection is applied to the input feature data for training the neural network. A trained neural network processes input features from a subject to generate an outcome function that reflects the probability of the occurrence of an event at a given time point for that subject.

### REFERENCE TO RELATED APPLICATIONS

This application claims the benefit of U.S. provisional patent application No. 60/340,087, filed Dec. 7, 2001 the complete disclosure of which is incorporated by reference herein.

### FIELD OF INVENTION

The present invention relates, in general, to methods for predicting a time-dependent outcome based on a large number of features. In particular, the invention relates to methods for predicting the survival time of a diseased patient based on biological information available for the patient.

### BACKGROUND

The estimated survival time for a cancer patient can be used by a clinician as a factor for determining an appropriate treatment strategy. Traditionally, the survival time for a patient with a disease can be predicted using an average survival time that was calculated from known survival data for patients with a similar disease. For patients with cancer, survival predictions are usually dependent on identifying the specific type of cancer. Improved methods for classifying cancers have been developed. These new classification schemes can be useful for predicting cancer survival. However, predicted survival times remain inaccurate and there is a need in the art for improved methods for predicting disease survival and other time-dependent clinical outcomes.

### SUMMARY

The invention provides a method of survival analysis and time-dependent outcome prediction that combines a hazard-based survival prediction model with a neural network analysis. Methods of the invention are useful to generate an outcome predictions based on a neural network analysis of a data set that include a large number of features relative to the number of subjects for which the feature data is obtained. The invention is useful to provide time-dependent predictions of medical or clinical outcomes such as survival time, time to disease recurrence, time to disease occurrence, time to drug side effect, time to death, or other clinical or medical time-dependent prediction. The predictions are based on data with large numbers of features, such as microarray data. In preferred embodiments, a prediction is based on gene expression data.

The invention provides methods for training neural networks to provide a time-dependent prediction. Methods of the invention include training a neural network using a training data set that include known time-dependent outcomes for a relatively small number of subjects for each of which a large number of features are available. In preferred embodiments, a training data set includes known time-dependent disease outcomes for patients and microarray gene expression data for those patients at an original time point.

In one aspect, the invention provides a method for generating a time-dependent outcome function for each of the subjects in the training data set. According to the invention, a time-dependent outcome function is generated for censored and non-censored subjects, thereby maximizing the amount of subject information that is used to train the neural network. These time dependent outcome functions are used as known output information to train a neural network.

In another aspect, the invention provides a feature selection method to reduce the number of features that are used as training input information. According to the invention, a separate subset of features is selected for each time point at which outcome information is available. These subsets are combined and used as training input features to train a neural network. In some embodiments, a further feature selection identifies features that are present in more than one of the subsets, and only these features are used as training input information.

In another aspect, the invention provides a method for training a network using the time dependent outcome functions and selected features discussed above. According to the invention, the error of the trained network can be evaluated by cross validation analysis. In some embodiments, a subset of the subject information is used for feature selection. The selected cross validation features are used along with the time dependent outcome functions to train the neural network. The trained network is then applied to the feature information for subjects left out from the training process. The predicted outcome is then compared to the known outcomes for those subjects, and a measure of the error associated with the neural network can be calculated.

In still another aspect, the invention features a system for predicting a time-dependent outcome based on the analysis of feature information that is available for a subject with little or no known actual outcome information. An appropriately trained neural network is applied to the feature information and the output is provided in the form of a time-dependent outcome function. According to the invention, time can be measured in seconds, minutes, hours, weeks, months, years, or multiples thereof. The time-dependent outcome function can be a hazard curve or a survival curve. However, other outcome functions can be used. In preferred embodiments, the subject is a patient and the predicted outcome is the occurrence, reoccurrence, or remission of a disease. Alternatively, the outcome can be the time-dependent occurrence of a drug response including a positive response or a negative drug side effect. According to the invention, the predicted outcome can be used to determine an appropriate treatment strategy for a patient.

In preferred embodiments, the invention is used to predict cancer survival or cancer occurrence/recurrence. The invention is particularly useful to predict the outcome for lung cancer, brain cancer, breast cancer, pancreatic cancer, stomach cancer, prostate cancer, bladder cancer, skin cancer, and any other form of cancer. The invention can also be used to predict the outcome of specific cancer or carcinoma subtypes.

In yet another aspect, the invention includes a computerized apparatus for implementing the algorithms of the invention. A trained network may be stored on a computer storage medium. The network model may be provided on the storage medium. Alternatively, the network model may be accessed remotely via a computer network, including a wireless computer network.

In some embodiments, a model of the invention is provided along with recommended therapeutic regimes tailored to different clinical outcome predictions.

In yet another aspect, the invention provides a subset of features that are useful for outcome prediction. In some embodiments, a useful subset is identified using a feature selection of the invention. This subset can then be used for subsequent outcome predictions. Alternatively, the subset can be examined to identify features that have a causal relationship with the outcome. The subset can also be used to choose input features for subsequent network training. A particularly useful subset of features is provided in Table 1. Table 1 lists a set of genes for which expression data can be used to predict lung cancer recurrence.

### DESCRIPTION OF THE DRAWINGS

FIG. 1 is a flowchart representation of method steps for training a neural network based on subject data with high feature-dimensionality relative to the number of subjects for which time-dependent event outcome information is available;

FIG. 2 is a more detailed flowchart representation of method steps where the information is split for cross-validation;

FIG. 3 is a flowchart of method steps of a feature selection that may be conducted in parallel with the generation of a time-dependent outcome function;

FIG. 4 shows a flowchart of steps for conducting a feature selection;

FIG. 5 shows a flowchart of steps for generating the training hazard functions for the neural network, for both censored and non-censored subjects;

FIG. 6 shows a flowchart for using a trained neural network to generate a predicted outcome;

FIG. 7 shows examples of training hazard curves for censored and non-censored subjects;

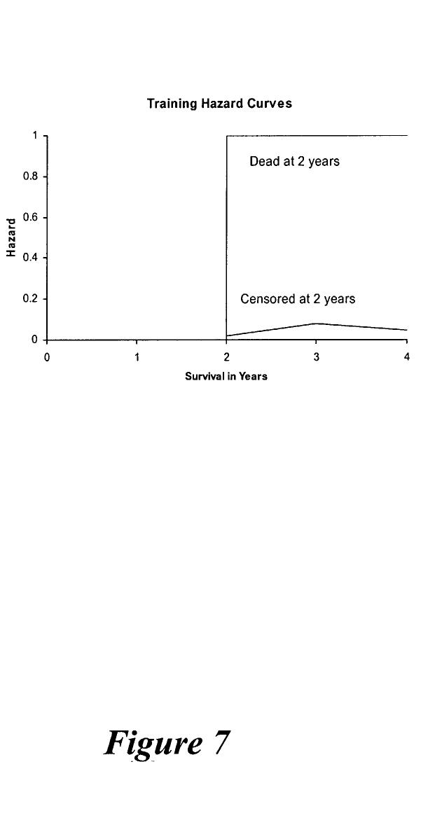

FIG. 8 shows the form of a survival function;

FIGS. 9A and 9B show plots of actual versus predicted recurrence time, in months, using recurrence cases only in 10-fold cross validation and leave-one-out validation experiments; and

FIG. 10 shows a plot of actual versus predicted outcomes, using recurrence cases only, in a 10-fold cross validation using a Cox Regression.

### DESCRIPTION OF THE INVENTION

The present invention relates to a method and apparatus for using a neural network to predict the occurrence of an event as a function of time. The invention provides methods for combining a neural network with a time-dependent outcome function (e.g. a hazard function) when training data is available only for a small number of subjects relative to the number of features being analyzed for each subject. Such methods are particularly useful for analyzing microarray gene expression data to predict the occurrence of an event such as the onset of disease. Typically, clinical data is available only for a small number of patients relative to the number of genes being assayed on a microarray for each patient. Over-training of the neural network can be a significant problem in such situations where the dimensionality of the training data for each subject is high relative to the number of subjects for which time-dependent information is available. An over-trained network attributes significance to irrelevant characteristics of the training data and is essentially useless for subsequent event predictions based on new input data.

Neural Network Training and Implementation.

Artificial neural networks are software algorithms modeled on the structure of the brain. One of advantage of neural networks is their general applicability to many types of diagnosis and classification problems. The general model of a neural network is described in U.S. Pat. No. 4, 912,647 to Wood. Neural networks may be trained using a set of input data and may be modeled to produce outputs in the form of a probability.

Neural networks have been used for detecting and classifying types normal and abnormal tissue cells as described in U.S. Pat. No. 6,463,438 issued to Veltri et al.; U.S. Pat. No. 6,208,983 issued to Parra et al. and in a publication by Kahn, Wei et al. ‘Classification and Diagnostic Prediction of Cancers Using Gene Expression Profiling and Artificial Neural Networks.” (Nature Medicine, 2001).

However, it has been difficult to exploit neural networks to produce outputs that predict survival rate as a probability based on data sets including a large number of features relative to the number of subjects for which the feature data is available. Such data sets include microarray gene expression data from small numbers of patients for which time dependent disease outcome information is available.

The invention provides several approaches to prevent or minimize over-training or over-fitting of a neural network when the training input is based on data with high-dimensionality relative to the number of subjects for which time-dependent information is available. An individual time-dependent outcome function is derived for each available subject to reflect the occurrence/non-occurrence of an event as a function of time for that subject. Such functions are derived for censored subjects in addition to non-censored subjects (see below), thereby maximizing the number of subjects that are used to generate input and output data for network training. For each time point to be used for network training, a separate feature selection is performed to select input features. A subset of input features can be further selected from the feature selections. The input features and the time-dependent outcome functions are then used to train the network. The trained network is useful to predict the occurrence of an event based on new input features selected from new subject information. The new information is processed using the same feature selection prior to being analyzed by the trained network. The network output is useful to predict the occurrence or non-occurrence of the event within the time period used for network training. In addition, the output can be extrapolated to predict occurrence or non-occurrence over a time period that extends beyond the time period used for network training.

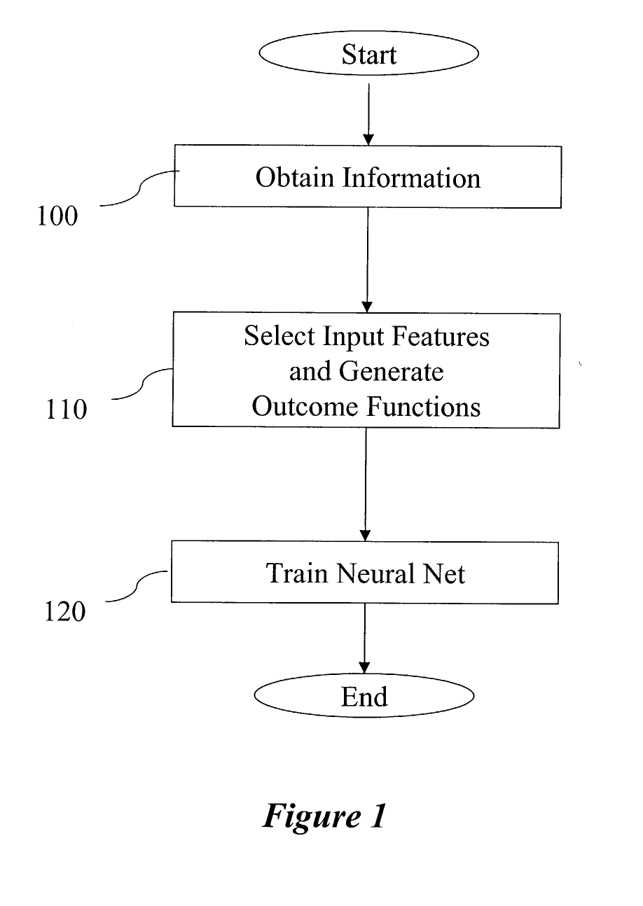

The flowchart in FIG. 1 describes one implementation of the present invention as a series of method steps for training a neural network based on subject data with high-dimensionality relative to the number of subjects for which time dependent event outcome information is available.

At step 100, information is obtained for the available subjects. The information includes time dependent observations reflecting the occurrence or non-occurrence of an event for each subject at several different time points. This is the time-dependent outcome data for each subject. This data is used to generate time-dependent outcome functions that are used to train and validate the neural network.

The subject information also includes a plurality of feature measurements for each subject. This information is used to generate the training input data. According to the invention, the dimensionality of the subject features is high, meaning that a high number of features is used to generate the input data for the neural network. In preferred embodiments, the dimensionality of the subject features is greater than the number of available subjects. The dimensionality of the subject features may be several fold greater than the number of subjects. The dimensionality of the subject features may be between about 1 fold and about 10 fold, between about 10 fold and about 100 fold, between about 100 fold and about 1000 fold, or over 1000 fold that of the number of subjects.

At step 110, input and output data is generated from the information of step 100. The input training features are selected using a time-dependent feature selection based on the subject information. The output data is generated in the form of a time-dependent outcome function reflecting the probability of an event occurring over time for each subject. The time points that are used for the input feature selection process are preferably the same as those used for the training output function. However, different time points may be used.

At step 120, the input features and output data from step 110 is used to train a neural net. Any type of neural network that is adapted for prediction analysis may be used. Useful neural networks include feed forward neural networks. A radial basis function can used as an activation function. Useful training functions include back propagation functions, radiant descent functions, and variants thereof. One or multiple hidden layers can be used. An appropriate training to testing ratio is used (e.g. 70/30, or other commonly accepted data split). Preferably the neural net has an output that can be used to derive a probability function (with values ranging between 0 and 1). Appropriate activation and error functions should be used, such as the logistic activation and cross entropy error functions used in Example 2 below. However, other activation and error functions can be used provided that the output of the neural net can be interpreted as a probability. Ultimately, at step 120 the neural network has been trained to predict a time-dependent occurrence of an event based on subject information that has high dimensionality relative to the number of subjects.

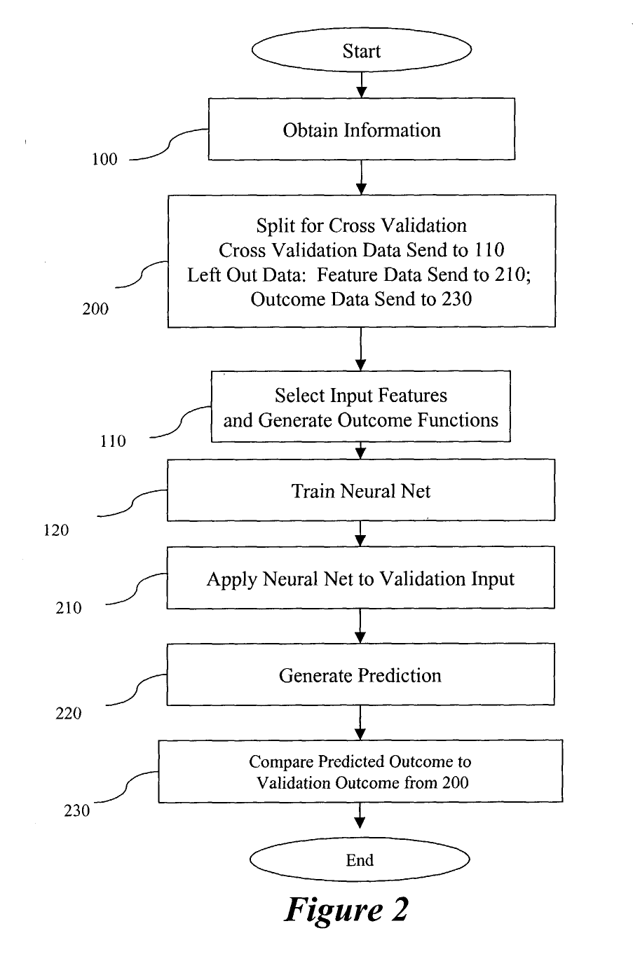

The flowchart in FIG. 2 describes an implementation of the present invention where the information from step 100 is split into “cross validation data” and “left-out data” at step 200. The cross validation data from step 200 is used in step 110 to select input features and generate outcome functions which are subsequently used to train the neural network at step 120. The left-out data from step 200 includes feature data and outcome data. In some embodiments, this data is not used at step 110 to select input features or generate outcome functions. The left-out feature data is used at steps 210 to 230 to validate the trained neural network from step 120.

At step 210, the trained neural network from step 120 is applied to the left-out feature data from step 200. At step 220, a prediction is made for the left-out feature data based on the neural network output from step 210. This prediction can be in the form of a hazard function, a survival function, or other function that reflects the time-dependent probability of an event occurring for each left-out subject. At step 230, the predicted outcome from step 220 is compared to the actual outcome of the left-out data from step 200. This comparison provides a measure of the error associated with the trained neural network of step 120.

In other embodiments, the outcome functions generated at step 110 are based on the entire data, including the cross validation data and the left-out data. However, the feature selection at step 110 is based only on the cross validation data.

In preferred embodiments, the validation data split at step 200 is a 10 fold cross validation: 90% of the data from step 110 is used to train the neural network at step 120, and 10% of the data from step 110 is left out and used to validate the trained neural networks at steps 210 to 230. This process is repeated 10 times, using a different 90/10 split of the data for each validation run. The results from step 230 of each validation run are then combined to provide a combined measure of the error associated with the neural network used in step 120. In other embodiments, the validation can be a leave-one-out validation, a 5 fold cross validation, or other form of validation that involves selecting a subset of data from step 110 to be used for training at step 120, and validating the trained neural network at steps 210 to 230 using the data that was left out at step 200. In general, it is preferable to use all of the data that is available from steps 100 and 110. However, one of ordinary skill will understand that a neural network can be trained and validated using less than all of the data from steps 100 and 110.

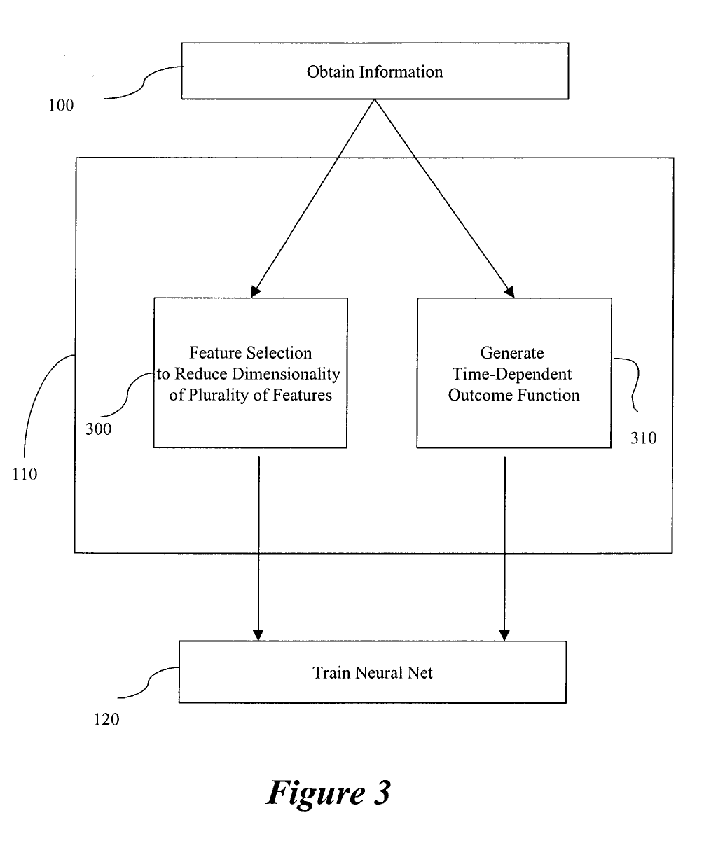

The flowchart in FIG. 3 describes in more detail one implementation of the present invention where step 110 includes two method steps 300 and 310. At step 300, a feature selection is applied to reduce the dimensionality of the subject features. At step 310, a time-dependent outcome function is generated to reflect the probability of an event occurring or not occurring as a function of time for each subject used in the analysis. Steps 300 and 310 are independent and can be performed simultaneously or sequentially in any order. An optional filtration/preprocessing step can be used prior to step 300 to remove features for which no or little measurements were available.

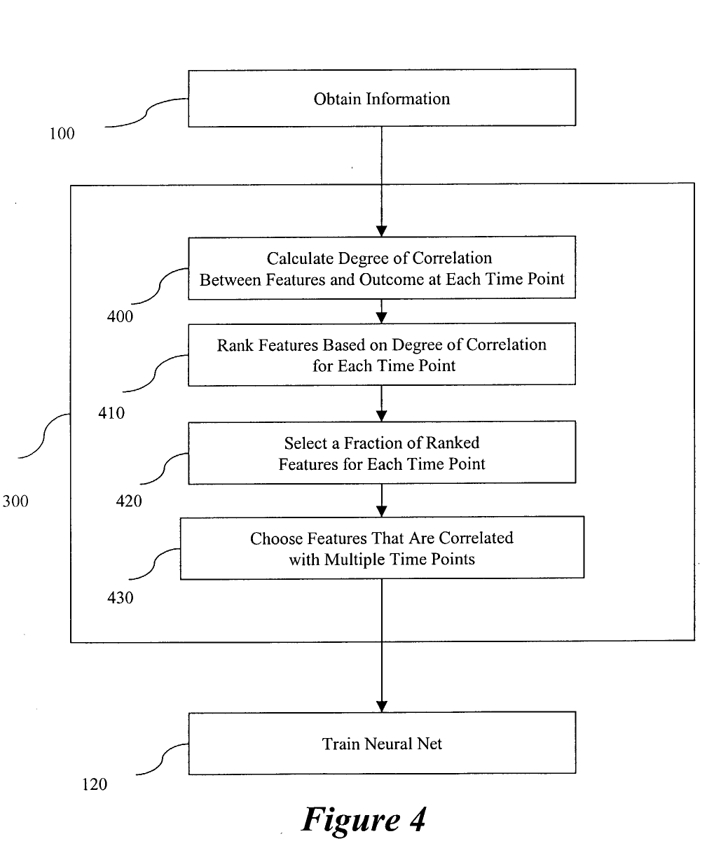

The flowchart in FIG. 4 describes in more detail one implementation of the present invention as a series of method steps for step 300 reducing the dimensionality of the subject data. In one embodiment, at step 400 a correlation is calculated for each time point between each feature and the outcome at that time point. Preferably, a Pearson correlation is used. However, other measures of correlation can be used to relate each feature to a known outcome at each time point.

At step 410, for each time point, the features are ranked based on their degree of correlation with the outcome at that time point. At step 420, a fraction of the features is selected for each time point. In one embodiment, the 50 most-correlated data items are selected for each time point further analysis. Preferably, the selected features are the top n-most correlated features, where n is an integer between 1 and 50. However, n may be greater than 50, greater than 100, or greater than 1000. Methods of the invention may be practiced using a subset of features that does not include the most highly ranked feature or features within the group of n-most correlated features. Methods of the invention also may be practiced using a subset of non-consecutively ranked features within the group of n-most correlated features. However, the selected feature are preferably the 1 to n consecutively ranked most correlated features. In general, the number of selected features is related to the number of subjects for which time-dependent information is available. The greater the number of available subjects, the greater the number of features that can be processed in step 120 without over-training the neural network.

In some embodiments, a step 430 optionally reduces the dimensionality of the features even further by choosing features that were selected for multiple time points at step 420 (e.g. features that were selected for at least two time points at step 420). Accordingly, a selected feature from step 420 that was highly correlated with only one time point is discarded.

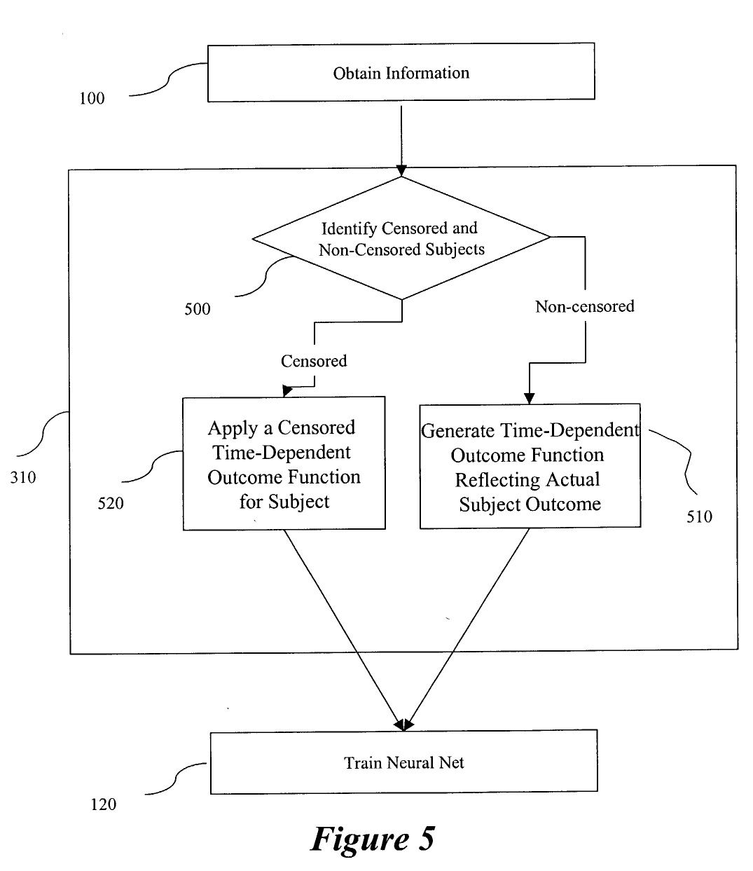

The flowchart in FIG. 5 describes in more detail one implementation of the present invention as a series of method steps for step 310 assigning a time-dependent outcome function to each subject. At step 500, a subject is identified a censored or non-censored subject. A non-censored subject is one for which time-dependent information relating to the occurrence/non occurrence of an event (outcome information) is available at all the time points within the study period. However, a subject is non-censored if the event occurs at a time point within the study period, and no information is available for time points after the occurrence of the event. In contrast, a censored subject is one for which the event has not occurred by one of the time points within the study and no outcome information is available for the study period beyond that time point.

At step 510, an outcome function is generated for a non-censored subject. This outcome function reflects the actual outcome for the subject. In preferred embodiments, the outcome function provides a probability value between 0 and 1 for the occurrence of the event at a given time point. Prior to the occurrence of the event, the probability is 0. Upon occurrence of the event, the probability is 1. The probability remains at 1 after the event has occurred.

At step 520, an outcome function is generated for a censored subject. This outcome function reflects the actual outcome for the subject up to the last observation for that subject. For time points beyond censoring, a censored outcome function is used to predict the probability of the event occurring at the subsequent time points. In preferred embodiments, a censored outcome function is generated based on a Kaplan-Meier function using data from all the available subjects at each time point. In other embodiments, a censored outcome function can be generated using a Cox regression hazard, or other hazard function.

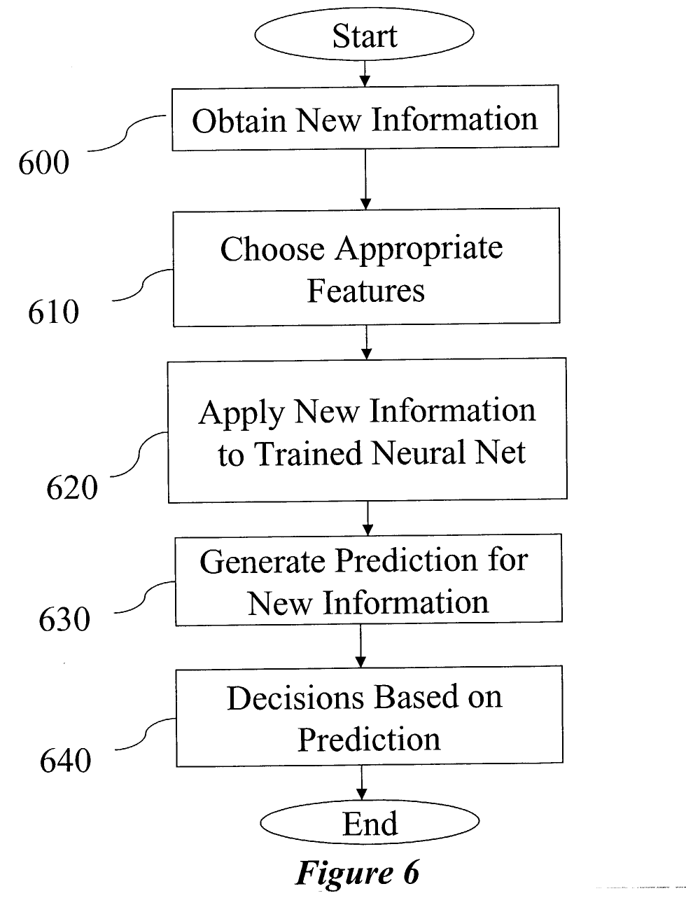

The flowchart in FIG. 6 describes one implementation of the present invention as a series of method steps for analyzing information from a new subject using a trained network of the invention.

At step 600, new information is obtained for one or more new subjects. A new subject is one whose information was not used to train or validate the neural network. This new information includes feature data for each subject. Typically, little or no information is available relating to each subject's outcome.

At step 610, a choice of appropriate features optionally is applied to the plurality of features to select input features that are the same as those identified by the feature selection at step 300 and used to train the neural network. However, features do not need to be chosen or selected when using the trained neural network because the trained network will ignore irrelevant features.

At step 620, the input features from step 610 are processed by the trained neural network. At step 630, a time dependent outcome function is generated. In one embodiment, this outcome function is a hazard function reflecting the probability of the event occurring as a function of time. Alternatively, the outcome function can be expressed as a survival function reflecting the probability of an event not occurring over time. In further embodiments, the output information can be expressed in other ways, for example: a mean time to occurrence or non-occurrence of an event, a median time to occurrence or non-occurrence of an event, the probability of occurrence or non-occurrence of an event before one or more predetermined time points, the probability of occurrence or non-occurrence of an event after one or more predetermined time points, the time by which an event has a predetermined probability of occurring, the time for which the probability that an event will not occur is below a predetermined threshold, and any other useful expression. The output may be expressed in the form of one or more numbers, tables, graphs, or in any other useful format.

In some embodiments, a step 640 optionally provides one or more decisions based on the predicted outcome function. For example, in a clinical setting the type of treatment a patient receives may be affected by the patient's predicted survival time or predicted time until recurrence of a disease such as cancer.

Time-Dependent Outcome Predictions Based on Clinical and Biological Features

The invention is particularly useful in a clinical setting, where large amounts of feature data may be available for a relatively small number of patients for which outcome information is available. The invention is particularly useful in the context of microarray gene expression analysis. However, the invention may also be used to analyze large numbers of clinical features. In particular embodiments, the invention is useful to analyze a combination of gene expression data and clinical data.

The invention is particularly useful to provide time-dependent probabilities for events such as disease occurrence, disease recurrence, remission, drug responses, drug side effects, death, and other clinical outcomes.

An individual or subject is not limited to a human being but may also be other organisms including but not limited to mammals, plants, bacteria or cells derived from any of the above.

Microarray Analysis.

Methods of the invention are exemplified using data from oligonucleotide microarrays. However, the invention extends to the analysis of other expression data, including data from cDNA microarrays. Given the nature of the data generated by the array-based interrogation of gene expression levels, methods of the invention are useful for the analysis of gene expression data across different organisms and different type of experiments. Methods of the invention are also applicable to other databases comprising large numbers of features, such as the emerging microarray interrogation of proteins. Methods of the invention are also applicable to other biological data such as in vitro or in vivo cellular measurements, patient data such as disease progression, drug responses including effectiveness and side effects, drug screens, population data such as polymorphism distributions, and epidemiological data. The invention is also useful for other data, including data based on intensity measurements (e.g. spectrophotometric or other intensity based assays).

Expression data for large numbers of genes are typically based on hybridization either to cDNA or to synthetic oligonucleotides. Despite some substantial technical differences, both approaches rely on high-resolution arrays measuring the expression level of each gene as a function of the gene transcript abundance. This abundance is in turn measured by the emission intensity of the region where the gene transcript is located in the scanned image of the microarray, and the signal is filtered to remove noise generated by the microarray background and non-specific hybridization.

According to the present invention, microarrays have many preferred embodiments and details known to those of the art are described in many patents, applications and other references.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. The same holds true for ranges in increments of 10⁵, 10⁴, 10³, 10², 10, 10⁻¹, 10⁻², 10⁻³, 10⁻⁴, or 10^{-5,} for example. This applies regardless of the breadth of the range.

The practice of the present invention may employ, unless otherwise indicated, conventional techniques and descriptions of organic chemistry, polymer technology, molecular biology (including recombinant techniques), cell biology, biochemistry, and immunology, which are within the skill of the art. Such conventional techniques include polymer array synthesis, hybridization, ligation, and detection of hybridization using a label. Specific illustrations of suitable techniques can be had by reference to the example herein below. However, other equivalent conventional procedures can, of course, also be used. Such conventional techniques and descriptions can be found in standard laboratory manuals such as Genome Analysis: A Laboratory Manual Series (Vols. I-IV), Using Antibodies: A Laboratory Manual, Cells: A Laboratory Manual, PCR Primer: A Laboratory Manual, and Molecular Cloning: A Laboratory Manual (all from Cold Spring Harbor Laboratory Press), Stryer (anyone have the cite), Gait, “Oligonucleotide Synthesis: A Practical Approach” 1984, IRL Press, London, Nelson and Cox (2000), Lehninger, Principles of Biochemistry 3^{rd} Ed., W. H. Freeman Pub., New York, N.Y. and Berg et al. (2002) Biochemistry, 5^{th} Ed., W. H. Freeman Pub., New York, N.Y. all of which are herein incorporated in their entirety by reference for all purposes.

The present invention can employ solid substrates, including arrays in some preferred embodiments. Methods and techniques applicable to polymer (including protein) array synthesis have been described in U.S. Ser. No. 09/536,841, WO 00/58516, U.S. Pat. Nos. 5,143,854, 5,242,974, 5,252,743, 5,324,633, 5,384,261, 5,424,186, 5,451,683, 5,482,867, 5,491,074, 5,527,681, 5,550,215, 5,571,639, 5,578,832, 5,593,839, 5,599,695, 5,624,711, 5,631,734, 5,795,716, 5,831,070, 5,837,832, 5,856,101, 5,858,659, 5,936,324, 5,968,740, 5,974,164, 5,981,185, 5,981,956, 6,025,601, 6,033,860, 6,040,193, 6,090,555, and 6,136,269, in PCT Applications Nos. PCT/US99/00730 (International Publication Number WO 99/36760) and PCT/US 01/04285, and in U.S. patent application Ser. Nos. 09/501,099 and 09/122,216 which are all incorporated herein by reference in their entirety for all purposes.

Patents that describe synthesis techniques in specific embodiments include U.S. Pat. Nos. 5,412,087, 6,147,205, 6,262,216, 6,310,189, 5,889,165 and 5,959,098 which are each incorporated herein by reference in their entirety for all purposes. Nucleic acid arrays are described in many of the above patents, but the same techniques are applied to polypeptide arrays.

The present invention also contemplates many uses for polymers attached to solid substrates. These uses include gene expression monitoring, profiling, library screening, genotyping, and diagnostics. Gene expression monitoring and profiling methods can be shown in U.S. Pat. Nos. 5,800,992, 6,013,449, 6,020,135, 6,033,860, 6,040,138, 6,177,248 and 6,309,822. Genotyping and uses therefore are shown in U.S. Ser. No. 10/013,598, and U.S. Pat. Nos. 5,856,092, 6,300,063, 5,858,659, 6,284,460, 6,361,947, 6,368,799 and 6,333,179 which are each incorporated herein by reference. Other uses are embodied in U.S. Pat. Nos. 5,871,928, 5,902,723, 6,045,996, 5,541,061, and 6,197,506 which are incorporated herein by reference.

The present invention also contemplates sample preparation methods in certain preferred embodiments. For example, see the patents in the gene expression, profiling, genotyping and other use patents above, as well as U.S. Ser. No. 09/854,317, U.S. Pat. Nos. 5,437,990, 5,215,899, 5,466,586, 4,357,421, and Gubler et al., 1985, Biochemica et Biophysica Acta, Displacement Synthesis of Globin Complementary DNA: Evidence for Sequence Amplification.

Prior to or concurrent with analysis, the nucleic acid sample may be amplified by a variety of mechanisms, some of which may employ PCR. See, e.g., PCR Technology: Principles and Applications for DNA Amplification (Ed. H. A. Erlich, Freeman Press, NY, N.Y., 1992); PCR Protocols: A Guide to Methods and Applications (Eds. Innis, et al., Academic Press, San Diego, Calif., 1990); Mattila et al., Nucleic Acids Res. 19, 4967 (1991); Eckert et al., PCR Methods and Applications 1, 17 (1991); PCR (Eds. McPherson et al., IRL Press, Oxford); and U.S. Pat. Nos. 4,683,202, 4,683,195, 4,800,159 4,965,188,and 5,333,675, each of which is incorporated herein by reference in their entireties for all purposes. The sample may be amplified on the array. See, for example, U.S. Pat. No 6,300,070 and U.S. patent application Ser. No. 09/513,300, which are incorporated herein by reference.

Other suitable amplification methods include the ligase chain reaction (LCR) (e.g., Wu and Wallace, Genomics 4, 560 (1989), Landegren et al., Science 241, 1077 (1988) and Barringer et al. Gene 89:117 (1990)), transcription amplification (Kwoh et al., Proc. Natl. Acad. Sci. USA 86, 1173 (1989) and WO88/10315), self-sustained sequence replication (Guatelli et al., Proc. Nat. Acad. Sci. USA, 87, 1874 (1990), WO/88/10315 and WO90/06995), selective amplification of target polynucleotide sequences (U.S. Pat. No. 6,410,276), consensus sequence primed polymerase chain reaction (CP-PCR) (U.S. Pat. No. 4,437,975), arbitrarily primed polymerase chain reaction (AP-PCR) (U.S. Pat. No. 5,413,909, 5,861,245) and nucleic acid based sequence amplification (NABSA). (See, U.S. Pat. Nos. 5,409,818, 5,554,517, and 6,063,603, each of which is incorporated herein by reference). Other amplification methods that may be used are described in, U.S. Pat. Nos. 5,242,794, 5,494,810, 4,988,617 and in U.S. Ser. No. 09/854,317, each of which is incorporated herein by reference.

Additional methods of sample preparation and techniques for reducing the complexity of a nucleic acid sample are described in Dong et al., Genome Research 11, 1418 (2001), in U.S. Pat. No. 6,361,947, 6,391,592 and U.S. patent application Ser. Nos. 09/512,300, 09/916,135, 09/920,491, 09/910,292, and 10/013,598, which are incorporated herein by reference in their entireties.

The present invention also contemplates detection of hybridization between ligands in certain preferred embodiments. See U.S. Pat. Nos. 5,143,854, 5,578,832; 5,631,734; 5,834,758; 5,936,324; 5,981,956; 6,025,601; 6,141,096; 6,185,030; 6,201,639; 6,218,803; and 6,225,625 and in PCT Application PCT/US99/06097 (published as WO99/47964), each of which also is hereby incorporated by reference in its entirety for all purposes.

The practice of the present invention may also employ conventional biology methods, software and systems. Computer software products of the invention typically include computer readable medium having computer-executable instructions for performing the logic steps of the method of the invention. Suitable computer readable medium include floppy disk, CD-ROM/DVD/DVD-ROM, hard-disk drive, flash memory, ROM/RAM, magnetic tapes and etc. The computer executable instructions may be written in a suitable computer language or combination of several languages. Basic computational biology methods are described in, e.g. Setubal and Medians et al., Introduction to Computational Biology Methods (PWS Publishing Company, Boston, 1997); Salzberg, Searles, Kasif, (Ed.), Computational Methods in Molecular Biology, (Elsevier, Amsterdam, 1998); Rashidi and Buehler, Bioinformatics Basics: Application in Biological Science and Medicine (CRC Press, London, 2000) and Ouelette and Bzevanis Bioinformatics: A Practical Guide for Analysis of Gene and Proteins (Wiley & Sons, Inc., 2^{nd} ed., 2001).

The present invention may also make use of various computer program products and software for a variety of purposes, such as probe design, management of data, analysis, and instrument operation. See, U.S. Pat. Nos. 5,593,839, 5,795,716, 5,733,729, 5,974,164, 6,066,454, 6,090,555, 6,185,561, 6,188,783, 6,223,127, 6,229,911 and 6,308,170.

Additionally, the present invention may have preferred embodiments that include methods for providing genetic information over the internet. See U.S. patent applications and provisional applications 10/063,559, 60/349,546, 60/376,003, 60/394,574, and 60/403,381.

The present invention provides a flexible and scalable method for analyzing complex samples of nucleic acids, including genomic DNA. These methods are not limited to any particular type of nucleic acid sample: plant, bacterial, animal (including human) total genome DNA, RNA, cDNA and the like may be analyzed using some or all of the methods disclosed in this invention.

Methods of this invention are preferably used to model event outcome based on array data. An “array” comprises a support, preferably solid, preferably with nucleic acid probes attached to the support. Preferred arrays typically comprise a plurality of different nucleic acid probes that are coupled to a surface of a substrate in different, known locations. These arrays, also described as “microarrays” or colloquially “chips” have been generally described in the art, for example, U.S. Pat. Nos. 5,143,854, 5,445,934, 5,744,305, 5,677,195, 5,800,992, 6,040,193, 5,424,186 and Fodor et al., Science, 251:767-777 (1991). Each of which is incorporated by reference in its entirety for all purposes.

Arrays may generally be produced using a variety of techniques, such as mechanical synthesis methods or light directed synthesis methods that incorporate a combination of photolithographic methods and solid phase synthesis methods. Techniques for the synthesis of these arrays using mechanical synthesis methods are described in, e.g., U.S. Pat. No. 5,384,261, and 6,040,193, which are incorporated herein by reference in their entirety for all purposes. Although a planar array surface is preferred, the array may be fabricated on a surface of virtually any shape or even a multiplicity of surfaces. Arrays may be nucleic acids on beads, gels, polymeric surfaces, fibers such as fiber optics, glass or any other appropriate substrate. (See U.S. Pat. Nos. 5,770,358, 5,789,162, 5,708,153, 6,040,193 and 5,800,992, which are hereby incorporated by reference in their entirety for all purposes.)

Arrays may be packaged in such a manner as to allow for diagnostic use or can be an all-inclusive device; e.g., U.S. Pat. Nos. 5,856,174 and 5,922,591 incorporated in their entirety by reference for all purposes.

Preferred arrays are commercially available from Affymetrix under the brand name GeneChip® and are directed to a variety of purposes, including genotyping and gene expression monitoring for a variety of eukaryotic and prokaryotic species. (See Affymetrix Inc., Santa Clara and their website at affymetrix.com.)

### EXAMPLES

### Example 1

### Materials and Methods

Specimens

A total of 203 snap-frozen lung tumors (n=186) and normal lung (n=17) specimens have been used to generate microarray gene expression data. Of these, 125 adenocarcinoma samples were associated with clinical data and with histological slides from adjacent sections. The 203 specimens include histologically-defined lung adenocarcinomas (n=127), squamous cell lung carcinomas (n=21), pulmonary carcinoids (n=20), SCLC (n=6) cases and normal lung (n=17) specimens. Other adenocarcinomas (n=12) were suspected to be extrapulmonary metastases based on clinical history.

Tumor and normal lung specimens were obtained from two independent tumor banks. The following specimens were obtained from the Thoracic Oncology Tumor Bank at the Brigham and Women's Hospital/Dana Farber Cancer Institute: 127 adenocarcinomas, 8 squamous cell carcinomas, 4 small cell carcinomas, and 14 pulmonary carcinoid samples. In addition 12 adenocarcinoma samples without associated clinical data were obtained from the Brigham/Dana-Farber tumor bank. In addition, 13 squamous cell carcinoma, 2 small cell lung carcinoma, and 6 carcinoid samples were obtained from the Massachusetts General Hospital (MGH) Tumor Bank. The snap-frozen, anonymized samples from MGH were not associated with histological sections or clinical data.

Frozen samples of resected lung tumors and parallel “normal” (grossly uninvolved) lung (protocol 91-03831) for anonymous distribution to IRB-approved research projects were obtained within 30 minutes of resection and subdivided into samples (˜100 mg). Samples intended for nucleic acid extraction was snap frozen on powdered dry ice and individually stored at −140° C. Each was associated with an immediately adjacent sample embedded for histology in Optimal Cutting Temperature (OCT) medium and stored at −80° C. Six micron frozen sections of embedded samples stained with H&E was used to confirm the post operative-pathologic diagnosis and to estimate the cellular composition of adjacent extraction samples as discussed below. Each selected sample was further characterized by examining viable tumor cells in H&E stained frozen sections comprising of at least 30% nucleated cells and low levels of tumor necrosis (<40%). In addition, at least once pulmonary pathologists (I and II) independently evaluated adjacent OCT blocks for tumor type and content. Notes were also taken for extent of fibrosis and inflammatory infiltrates.

Clinical data from a prospective database and from the hospital records included the age and sex of the patient, smoking history, type of resection, post-operative pathological staging, post-operative histopathological diagnosis, patient survival information, time of last follow-up interval or time of death from the date of resection, disease status at last follow-up or death (when known), and site of disease recurrence (when known). Code numbers were assigned to samples and correlated clinical data. The linkup between the code numbers and all patient identifiers was destroyed, rendering the samples and clinical data completely anonymous.

125 adenocarcinoma samples were associated with clinical data. Adenocarcinoma patients included 53 males and 72 females. There were 17 reported non-smokers, 51 patients reporting less than a 40 pack-year smoking history, and 54 patients reported a greater than 40 pack-year smoking history. The post-operative surgical-pathological staging of these samples included 76 stage I tumors, 24 stage II tumors, 10 stage III tumors, and 12 patients with putative metastatic tumors. Note that numbers do not always add to 125, as complete information could not be found for each case.

RNA extraction and Microarray Experiments

Briefly, tissue samples were homogenized in Trizol (Life Technologies, Gaithersburg, Md.) and RNA was extracted and purified using the RNEASY column purification kit (QIAGEN, Chatsworth, Calif.). RNA extracted from samples that were collected from two different OCT blocks was given the sample code name followed by the corresponding OCT block name. Denaturing formaldehyde gel electrophoresis followed by northern blotting using a beta-actin probe assessed RNA integrity. Samples were excluded if beta-actin was not full-length.

Preparation of in vitro transcription (IVT) products and oligonucleotide array hybridization and scanning were performed according to Affymetrix protocol (Santa Clara, Calif.). In brief, the amount of starting total RNA for each IVT reaction varied between 15 and 20 mg. First strand cDNA synthesis was generated using a T7-linked oligo-dT primer, followed by second strand synthesis. IVT reactions were performed in batches to generate cRNA targets containing biotinylated UTP and CTP, which was subsequently chemically fragmented at 95° C. for 35 minutes. Ten micrograms of the fragmented, biotinylated cRNA was mixed with MES buffer (2-[N-Morpholino]ethansulfonic acid) containing 0.5 mg/ml acetylated bovine serum albumin (Sigma, St. Louis, Mo.) and hybridized to Affymetrix (Santa Clara, Calif.) HGU95A v2 arrays at 45° C. for 16 hours. HGU95A v2 arrays contain ˜12600 genes and expressed sequence tags. Arrays were washed and stained with streptavidin-phycoerythrin (SAPE, Molecular Probes). Signal amplification was performed using a biotinylated anti-streptavidin antibody (Vector Laboratories, Burlingame, Calif.) at 3 μg/ml. A second staining with SAPE followed this. Normal goat IgG (2 mg/ml) was used as a blocking agent. Scans on arrays were performed on Affymetrix scanners and the expression value for each gene was calculated using Affymetrix GENECHIP software. Minor differences in microarray intensity were corrected for.

### Example 2

### Survival Prediction for Lung Cancer Patients

Gene expression and time-dependent survival information was obtained for 103 patients diagnosed with lung adenocarcinomas. For each patient, gene expression data was prepared from cancerous tissue obtained at the time of tumor resection. The patients were followed over time, and monitored for cancer recurrence. In this experiment, survival time is defined as the time to cancer recurrence. The patient information was used to train and evaluate neural networks according to the invention.

Filtration/preprocessing of feature data. The raw gene expression data from 12,600 genes on an Affymetrix microarray was filtered to remove genes with expression levels below an informative threshold. A 20-16000 threshold was used, whereby microarray measurements below 20 are set to 20 and measurements above 16000 are set to 16000. A 3-100 range was used, whereby features that did not vary by more than 3 fold and by more than 100 units were filtered out. For each feature, variation was assessed over the entire data set. This filtration process identified 5,498 genes for further analysis. In this embodiment, the data is comprised of genes. The filtration/preprocessor filters the genes so that a total of less than 5500 expressed genes remain for processing.

Initial analysis of survival information. The patient information included different lengths of time over which patient survival was monitored. The patient information was collected from a series of patients over time. More survival information was available for patients that were from the earlier part of the patient study group. Out of the 103 patients, 52 had the disease at the last follow up (these are the non-censored patients), and 51 were without disease (these are the censored patients). However, the frequency of follow up varied from patient to patient and the resulting time points for recurrence analysis were different throughout the patient population. Due to the limited data, the survival time was converted into years, and the outcome for each patient was recorded at each year as a 0 if no recurrence was observed by that year, and as a 1 after recurrence.

Hazard functions. A training hazard function was derived for each patient. A time period of 5 years was chosen, in part, because this time period is clinically relevant, and survival differences on the order of several years can determine different treatment recommendations for patients. For each non-censored patient, the hazard curve indicates the actual outcome of that patient at each yearly time point, with a 0 for each time point prior to recurrence and a 1 for each time point after recurrence. For each censored patient, the hazard curve indicates the actual outcome for that patient up to the last available follow up point. After censoring (i.e. after the last available follow up point), a Kaplan-Meier hazard curve is used for the patient. The Kaplan-Meier hazard curve is obtained using data from the entire population (including censored and non-censored patients). These hazard functions are used as training outputs for the neural network. In this experiment, a 10-fold cross validation is applied and 90% of the hazard functions are used for training in each cross validation run. Experiments were also performed using a leave-one-out cross validation.

Feature selection. For each time point (each of the 5 year time points), a Pearson correlation was computed to evaluate the correlation of each of the filtered genes with recurrence/non recurrence at that time point. The genes were ranked based on their correlation, and the top 50 genes were selected for each target time point. This generated 5 groups of maximally correlated genes (1 group for each year). Genes were selected further by choosing genes that were present in 2 or more of the 5 groups of maximally correlated genes. This generated a total of about 50-60 genes depending on the cross validation run the genes were selected in. Leave-one-out and 10-fold cross validations were performed. In each cross validation run, the Pearson correlation was calculated at each time point based on the gene expression data for the patients that were used for training. The Pearson correlation did not use the gene expression data for the patients that were left out for validation. Accordingly, 10 sets of 50-60 genes are identified when a 10 fold cross validation is applied. Table 1 shows the genes that are present most frequently in the sets of 50-60 genes selected from 10 fold cross validation runs.

TABLE 1

| Affymetrix | |
|---|---|
| Ref. No. | Gene Name |
| 41221_at | Physphoglycerate mutase 1 (brian) |
| 40108_at | KIAA0005 gene product |
| 36564_at | Cluster Incl W27419:31a 10 Homo sapiens cDNA |
| | /gb = W27419/gi = 1307241/ug = Hs.64239/len = 803 |
| 34891_at | Cluster Incl AI540958:PEC1.2_15_Hol.r Homo sapiens |
| | cDNA, 5 end/clone_end = 5″/gb = AI540958/gi = |
| | 4458331/ug = Hs.5120 |
| /len = 808 | |
| 1788_s_at | Dual specificity phosphatase 4 |
| 40075_at | Tumor protein D52-like 2 |
| 38835_at | Transmembrane 9 superfamily member 1 |
| 38833_at | Cluster Incl X00457:Human mRNA for SB classII |
| | histocompatibility antigen alpha-chain |
| | /cds = (0,702)/gb = X00457/gi = 36405/ug = Hs.914/len = |
| | 1048″ |
| 37720_at | Heat shock 60kD protein 1 (chaperonin) |
| 895_at | Macrophage migration Inhibitory factor (glycasylation-in- |
| | hibiting factor) |
| 40544_g_at | Achaete-scute complex (Drosophila) homolog-like 1 |
| 38394_at | KIAA0089 protein |
| 37697_s_at | Cluster Incl L08666:Homo sapiens porin (por) mRNA, |
| | complete cds |
| | and truncated cds |
| | /cds = UNKNOWN/gb = L08666/gi = 190199/ug = |
| | Hs.78902/len = 1464 |
| 37344_at | Major histocompatibility complex, class II, DM alpha |
| 33944_at | Amyloid beta (A4) precursor-like protein 2 |
| 33917_at | Erythrocyte membrane protein band 4.1-like 1 |

The 50-60 genes generated from a feature selection are used to train a neural network.

Neural network. A multi-layer perceptron was used with one hidden layer. A 70/30 training/test data split was used to train the neural net. Appropriate activation and error functions were used to generate an output that can be interpreted as a probability (with output values between 0 and 1). The following logistic activation was used (Equation 1):

$$ϕ ( v ) = \frac{1}{1 + {ⅇ}^{- v}}$$

The following cross entropy function (also known as multiple entropy or a Kulback labeler) was used (Equation 2):

$$E = {\sum }_{i} {\sum }_{k} 2 \{ {y}_{i k} ln ( \frac{{y}_{ik}}{{μ}_{i k}} ) + ( 1 - {y}_{i k} ) ln \frac{1 - {y}_{ik}}{1 - {μ}_{i k}} \}$$

Neural Net Output. The neural net provided vector estimates of the 5-year hazard for a patient (i) based on the patient's input data. This was provided as a hazard function. The hazard function was converted to a survival function as follows (Equation 3) where hᵢ(t) is the hazard at time t patient i:

Sᵢ(t)=Sᵢ(t−1)×[1−hᵢ(t)]

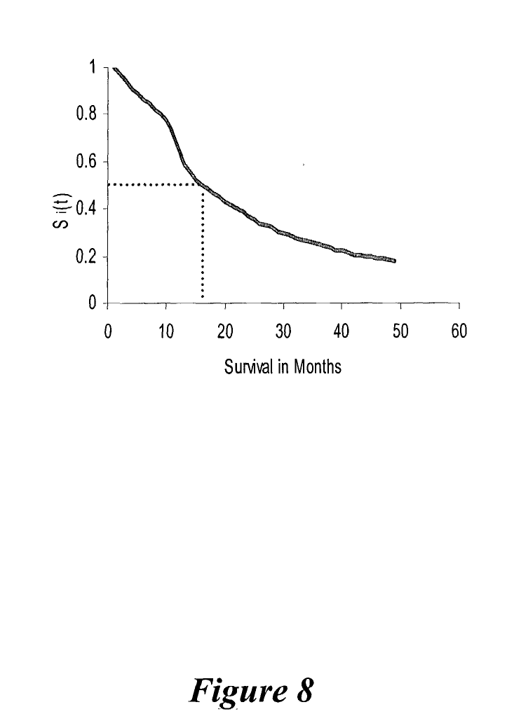

FIG. 8 shows the form of a survival function. The predicted time to recurrence (the survival) is chosen as the time when the survival function falls to 0.5 (the median survival time). If the curve has not reached 0.5 by year 5, the curve can extrapolated (e.g. linearly) to provide an estimate of the predicted time to recurrence. In general, if the predicted time to recurrence has not reached 0.5 by the end of the analysis time (e.g. 5 years in this example) for a small fraction of the patients (e.g. about 5%), the model is not weakened. However, the model may not be good if the predicted time to recurrence has not reached 0.5 by the end of the analysis time for a significant number of the patients used to generate the model.

The survival time is expressed in months in FIG. 8. This is achieved by interpolating the hazard curve or the survival curve between the yearly time points provided by the model (the trained neural net).

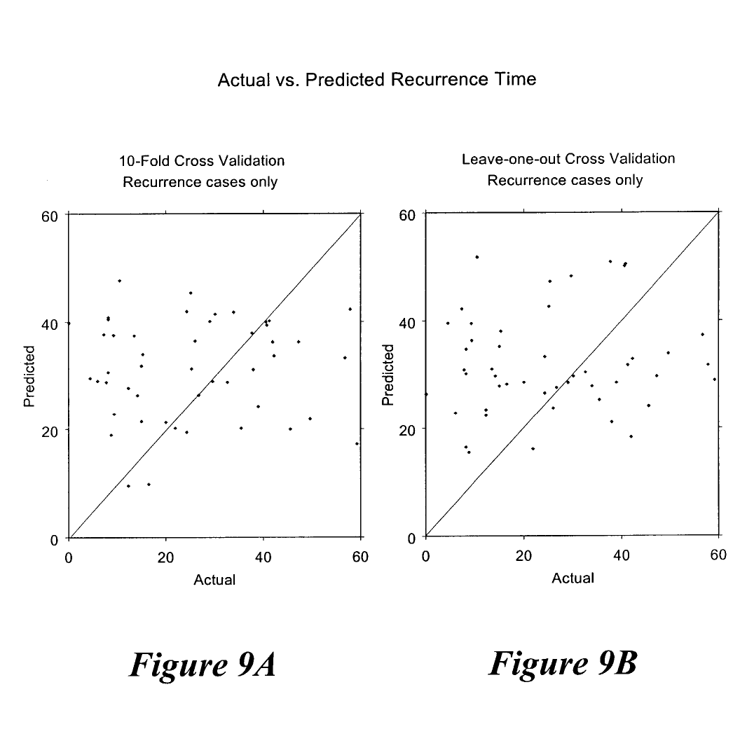

Comparison of predicted survival and actual survival. The strength of the model was evaluated by plotting the actual outcome (actual survival time) versus the predicted outcome (predicted survival time) and calculating the RMS errors in 10 fold cross validation and leave-one-out cross validation experiments. FIGS. 9A and 9B show the plots of actual versus predicted outcomes using recurrence cases only in 10-fold cross validation and leave-one-out validation experiments, respectively. The diagonal lines represent perfect predictions. The RMS error for the actual versus predicted survival was calculated and is shown in Table 2.

TABLE 2

| | | Leave one out |
|---|---|---|
| | 10 fold CV | CV |
| Recurrence cases only | 21.9 | 22.5 |

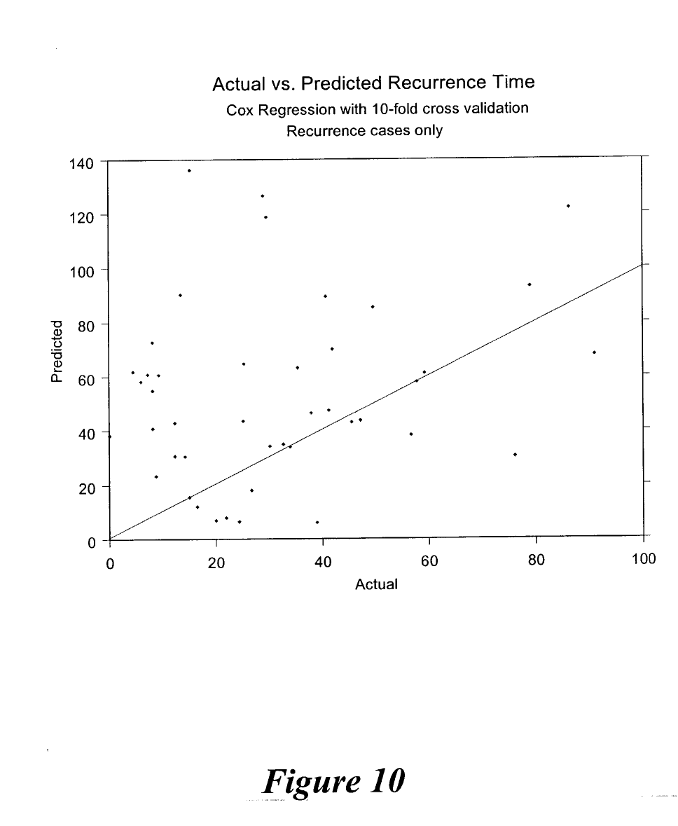

The RMS error associated with the model predictions was compared to a) the RMS error for a cox using 10 fold cross validation, and b) the RMS error for a cross validation of a method where the prediction is based on a mean survival time calculated from the known patient outcome information. FIG. 10 shows the plot of actual versus predicted outcomes using recurrence case only in a 10-fold cross validation using cox regression. The results are shown in Table 3.

TABLE 3

| | Neural Network | | Cox | |
|---|---|---|---|---|
| | 10 fold | Leave one | Regression | |
| | CV | out CV | 10 fold CV | CV Mean |
| Recurrence cases only | 21.9 | 22.5 | 305.9 | 24.5 |

The data in table 3 shows that the neural network provides a prediction that is better than a prediction based on a Cox regression analysis or a cross validation mean.

The neural net model was also evaluated by calculating the mean and standard deviation for (actual—predicted). The results are shown in table 4.

TABLE 4

| | | | Cox | |
|---|---|---|---|---|
| Recurrence cases | Neural Network | | Regression | CV |
| only | 10-fold CV | Leave one out CV | 10-fold CV | Mean |
| Mean | −1.9 | −2.1 | −91.9 | −11.5 |
| Standard | 22.0 | 22.7 | 294.7 | 21.9 |
| Deviation | | | | |

This data is significant, because a comparison of the means shows that the predictions from the neural network are generally closer to the actual outcome than the predictions from the Cox regression or the cross validation mean. The standard deviations are similar for the different predictions, indicating that the conclusions based on comparing the means are significant.

### Example 3

### Neural Network Analysis of Brain Tumor Cases with Gene Expression

Information from 68 gliomas was analyzed essentially as described in Example 2. The status of the 68 patients at the time of the last follow up was as follows. 32 alive (censored) and 36 dead (not censored). The survival time was available in months. The analysis was done using 4 output units (survival at 4 yearly increments). The results were similar to those shown in Example 2. The actual versus predicted outcomes were plotted. The RMS error for the actual versus predicted was calculated for deceased cases and is shown in Table 5.

TABLE 5

| | Root Mean Square | Mean Model |
|---|---|---|
| | Error (RMS) | 10-fold CV |
| Initial (non-recurrent) cases, 10-fold | 7.42 | |
| CV | | |
| Initial cases model applied to | 5.87 | |
| Recurrent cases | | |
| All cases (initial & recurrent), | 8.04 | 10.35 |
| 10-fold CV | | |

This shows that the predictions based on the brain tumor data are better than the predictions based on the lung cancer data.

The invention may be embodied in other specific forms without departing from the spirit or essential characteristics thereof. The foregoing embodiments are therefore to be considered in all respects illustrative rather than limiting on the invention described herein.

Each of the patent documents and scientific publications disclosed herein is incorporated by reference into this application in its entirety

What is claimed is:

1. A method of training a neural network for outcome prediction, the method comprising the steps of:
a. providing information for a plurality of subjects, said information comprising for each subject:
i. a plurality of features; and,
ii. a known outcome as a function of time;
b. selecting input features from the plurality of features;
c. generating a time-dependent outcome function for each subject; and
d. training a neural network using the selected input features and the time-dependent outcome functions for all the subjects, wherein said plurality of features is greater than said plurality of subjects for which feature information is available.

2. The method of claim 1, wherein the time-dependent outcome function for each subject is a hazard function reflecting the probability of an event at a plurality of observed time points.

3. The method of claim 1, wherein the plurality of features corresponds to microarry gene expression data.

4. The method of claim 1, wherein the neural network is a feed forward network.

5. The method of claim 1 wherein the feature selection of step b comprises the steps of:
i. calculating the degree of correlation between each feature and actual outcome at each time point;
ii. for each time point, ranking the features based on their degree of correlation with outcome at that time point;
iii. for each time point, selecting a fraction of ranked features; and
iv. selecting the input features from the fractions identified at step iii.

6. The method of claim 5, wherein a Pearson correlation is used for calculating the degree of correlation between features and outcome of each time point.

7. The method of claim 5, wherein the input features are selected at step iv by choosing features that are included in the fraction of step iii for at least two time points.

8. The method of claim 1 wherein the time-dependent outcome function has values ranging between 0 and 1, with values near 0 indicating a low likelihood of the event occurring, and values near 1 indicating a high likelihood of the event occurring.

9. The method of claim 1 wherein the step of generating a time-dependent outcome function for each subject is further comprised of:
i. identifying a subject as either censored or non-censored;
ii. applying a censored time-dependent outcome function if the subject is censored;
iii. generating an actual time-dependent outcome function if the subject is non-censored.

10. The method of claim 9, wherein the censored time-dependent outcome function is generated using a Kaplan-Meier function.

11. The method of claim 9, wherein the censored time-dependent outcome function is generated using a Cox regression.

12. The method of claim 1 wherein the neural network is implemented on a computer.

13. A method of assigning a probability of an event occurring at a given time comprising:
a. providing a plurality of features;
b. applying a trained neural network to said features; and
c. generating a time-dependent outcome function based on the output of the neural network,
wherein said neural network was trained using based on subject information comprising more features than the number of subjects for which the feature information was available.

14. The method of claim 1 or 13, wherein said event is selected from the group consisting of disease occurrence, disease recurrence, death, a toxic side effect to a drug, a positive response to a drug, remission.

15. The method of claim 14, wherein said disease is cancer.

16. The method of claim 15, wherein said cancer is selected from the group consisting of lung cancer, brain cancer, colon cancer, bladder cancer, breast cancer, and prostate cancer.

17. A neural network trained according to the method of claim 1.

18. A computer system comprising the neural network of claim 17.

19. The neural network of claim 17, wherein said neural network is on a data storage medium.
